(19) United States
(12) Patent Application Publication
(10) Pub. No.: US 2023/0070344 A1
(43) Pub. Date: Mar. 9, 2023

(54) METHOD AND DEVICE FOR GENERATING A MODEL FOR USE IN A TEST PROCEDURE FOR AN ENTRY SYSTEM OF A VEHICLE

(71) Applicant: KNORR-BREMSE GESELLSCHAFT MIT BESCHRÄNKTER HAFTUNG, Mödling (AT)

(72) Inventors: Johann BRAMAUER, Ybbsitz (AT); Reinhard EKKER, Scheibbs (AT)

(21) Appl. No.: 17/797,705

(22) PCT Filed: Feb. 1, 2021
(86) PCT No.: PCT/EP2021/052330

§ 371 Date: Aug. 4, 2022

(30) Foreign Application Priority Data
Feb. 4, 2020 (EP) 20155319.5

(51) Int. Cl. E05F 15/41; G05B 15/02; G05B 23/02

(52) U.S. Cl. CPC E05F 15/41; G05B 15/02; G05B 23/0243; G05B 2219/2628; G05B 2219/45015; G05B 2219/45242

(57) ABSTRACT

A method for generating an individual model may be for use in a test procedure for a rail vehicle entry system, the model having a nominal curve describing a normal state of the entry system. The generation of the individual model for the entry system makes it possible, during a subsequent assessment or examination of a current condition of the entry system, to give more detailed information than, for example, when a model generically generated on a test rig may be used. The method includes at least reading and/or receiving, and generating operations. During reading, a surroundings signal may be read, which represents information on surroundings of the entry system. During receiving, a process signal may be received, which represents process information of the entry system generated during operation of the entry system. During generating, the model may be generated using the surroundings signal and/or the process signal.

### CROSS REFERENCE AND PRIORITY CLAIM

This patent application is a U.S. National Phase of International Patent Application No. PCT/EP2021/052330, filed Feb. 1, 2021, which claims priority to European Patent Application No. 20155319.5, the disclosure of which being incorporated herein by reference in their entireties.

### FIELD

The present approach relates to a method and a device for creating a model for use in a test procedure for an entry system for a vehicle.

### BACKGROUND

Entry systems of a vehicle are usually checked manually according to a predefined maintenance plan without recording data. Before start-up, so-called “burn-in” tests are already performed in some projects, that is to say the entry system completes a predefined number of closing and opening cycles to thus identify any faults. However, associated recording of process and environment data has hitherto not taken place. Currently, data are recorded in entry systems during the entire operating time.

### SUMMARY

Against this background, the object of the present approach is to provide an improved method for creating a model for use in a test procedure for an entry system for a vehicle and an improved device for creating a model for use in a test procedure for an entry system for a vehicle.

### BRIEF DESCRIPTION OF THE FIGURES

Exemplary embodiments of the approach presented here are explained in more detail in the following description with reference to the figures, in which:

FIG. 1 shows a schematic illustration of a device for creating a model for use in a test procedure for an entry system for a vehicle according to one exemplary embodiment; and

FIG. 2 shows a flowchart of a method for creating a model for use in a test procedure for an entry system for a vehicle according to one exemplary embodiment.

In the following description of favorable exemplary embodiments of the present approach, identical or similar reference signs are used for the elements which are illustrated in the various figures and have a similar effect, in which case a repeated description of these elements may be dispensed with.

### DETAILED DESCRIPTION

Against this background, the disclosed embodiments provide an improved method for creating a model for use in a test procedure for an entry system for a vehicle and an improved device for creating a model for use in a test procedure for an entry system for a vehicle.

The present approach may create an individual model for an entry system and describes a normal state of the entry system. A subsequent test run of the entry system for determining a state of the entry system can provide particularly accurate test results using this individual model.

A method for creating a model for use in a test procedure for an entry system for a vehicle comprises a reading-in operation and additionally or alternatively a receiving operation and a producing operation. In the reading-in operation, an environment signal representing an item of information relating to an environment of the entry system may be read in. In the receiving operation, a process signal representing an item of process information relating to the entry system that may be generated during operation of the entry system is received. In the producing operation, the model may be produced using the environment signal and additionally or alternatively the process signal.

This method may be implemented, for example, in software or hardware or in a mixed form of software and hardware, for example in a control unit.

The entry system may be a door system, which can be electronically opened and additionally or alternatively electronically closed. The entry system may be used for the entry and exit of persons into or from the vehicle, which may be a rail vehicle, for example. The vehicle may also have a plurality of such entry systems, wherein each of the entry systems may have its own door control unit. The environment signal may represent an item of information relating to a current or defined environment of the entry system. For example, the environment signal may represent an item of information relating to an environmental condition such as a location of the entry system.

The environment signal may be read in from an environment sensor or an input apparatus for manually inputting the information. The process signal may comprise at least one item of process information relating to the entry system that may be generated during a resilience test, also called “burn-in test”, of the entry system. Additionally or alternatively, the process signal may comprise an item of process information relating to the entry system that may be generated during normal operation of the entry system. The model may be a nominal curve or the model may comprise such a nominal curve which describes a normal state of the entry system. As a result of this individual model being produced for the entry system, more accurate statements can be made when subsequently assessing a current state of the entry system than when using a model/nominal curve generically recorded on a sample test bench, for example.

At least one embodiment has a performing operation in which the test run of the entry system may be performed using the model produced in the producing operation to obtain a test result. The test run or test procedure may be a test method carried out on the entry system for the purpose of predicting the state of the entry system. During this test method, checks/wear measurements can be carried out on the entry system, for example, to be able to identify whether maintenance measures are necessary. Such a method is also referred to in English as “condition based maintenance”, “CBM” for short, or “predictive maintenance”. The performing operation now advantageously makes it possible to obtain a particularly meaningful test result since it takes into account the individual normal state of the entry system.

The method may also comprise a comparing operation in which the test result may be compared with a reference test result which was obtained based on a reference test procedure performed using a reference model which was produced using a reference environment signal and additionally or alternatively a reference process signal and a reference entry system and additionally or alternatively process and environment signals from operation. The reference model may have been previously produced using the reference entry system on a sample test bench in an identical manner to the model. The reference test result may be used to determine anomalies.

According to an embodiment, the method may also have an outputting operation in which a discrepancy signal may be output to a communication interface to a tester, wherein the discrepancy signal may be designed to indicate a discrepancy between the reference entry system and the entry system if the test result and the reference test result do not correspond within a tolerance range in the comparing operation. Such a discrepancy signal may make the examiner aware of a necessary correction to the entry system.

The reading-in and additionally or alternatively receiving and producing operations may be automatically repeated in a predetermined interval of time. This enables a model which is always up-to-date.

In accordance with at least one embodiment, a generating operation is performed before the reading-in operation, wherein, in the generating operation, the process signal is generated using stored process information representing process information sensed and stored during operation of the entry system in a defined environment. The process signal can therefore be generated and provided for the producing operation.

The method may also have a storing operation before the generating operation, wherein process information sensed during operation of the entry system in the defined environment of the entry system may be stored on a non-volatile storage apparatus in the storing operation. This makes it possible to collect process data for subsequent evaluation and for the production of the model.

The approach presented here also provides a device which may be designed to perform, control or implement the operations of a variant of a method presented here in corresponding apparatuses. This embodiment variant of the approach in the form of a device may also be used to quickly and efficiently achieve the object on which the approach may be based.

For this purpose, the device may have at least one computing unit for processing signals or data, at least one storage unit for storing signals or data, at least one interface to a sensor or an actuator for reading in sensor signals from the sensor or outputting data or control signals to the actuator, and/or at least one communication interface for reading in or outputting data, which are embedded in a communication protocol. The computing unit may be, for example, a signal processor, a microcontroller or the like, wherein the storage unit may be a flash memory, an EPROM or a magnetic storage unit. The communication interface may be designed to read in or output data in a wireless and/or wired manner, wherein a communication interface which can read in or output wired data can read in these data electrically or optically from a corresponding data transmission line or can output them to a corresponding data transmission line, for example.

In the present case, an apparatus can be understood as meaning an electrical unit which processes sensor signals and outputs control and/or data signals on the basis thereof. The device may have an interface which may be designed using hardware and/or software. In the case of a hardware design, the interfaces may be, for example, part of a so-called system ASIC which comprises a wide variety of functions of the device. However, it is also possible for the interfaces to be separate, integrated circuits or to be at least partially composed of discrete components. In the case of a software design, the interfaces may be software modules which are present on a microcontroller in addition to other software modules, for example.

In one useful configuration, the device controls a method for creating a model for use in a test procedure for an entry system for a vehicle. For this purpose, the device may access, for example, sensor signals such as an environment signal representing an item of information relating to an environment of the entry system and additionally or alternatively a process signal representing an item of process information relating to the entry system that may be generated during operation of the entry system. Control may be effected via actuators such as a reading-in apparatus, which may be designed to read in the environment signal and additionally or alternatively to receive the process signal, and a production apparatus which may be designed to produce the model using the environment signal and additionally or alternatively the process signal.

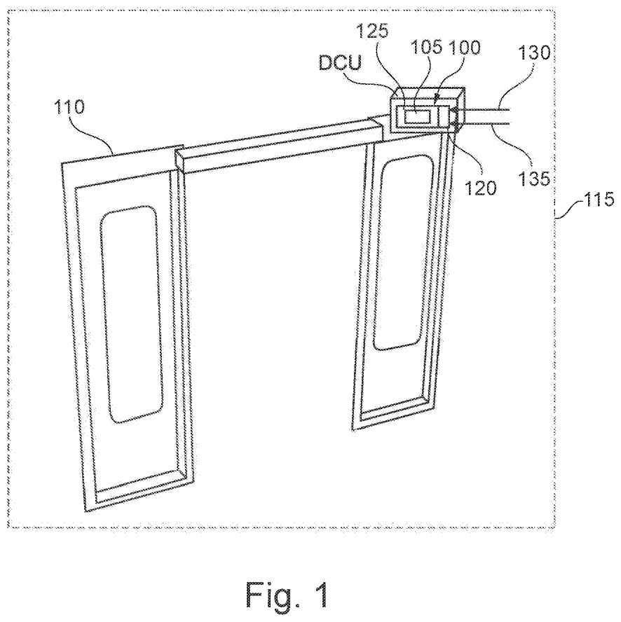

FIG. 1 shows a schematic illustration of a device 100 for creating a model 105 for use in a test procedure for an entry system 110 for a vehicle 115 according to one exemplary embodiment.

The device 100 has a reading-in apparatus 120 and a production apparatus 125. The reading-in apparatus 120 may be designed to read in an environment signal 130 representing an item of information relating to an environment of the entry system 110. According to this exemplary embodiment, the reading-in apparatus 120 may be additionally or alternatively designed to receive a process signal 135 representing an item of process information relating to the entry system 110 that may be generated during operation of the entry system 110. The production apparatus 125 may be designed to produce the model 105 using the environment signal 130 and/or the process signal 135.

According to one alternative exemplary embodiment, the device 100 also has a receiving apparatus which may be specifically designed to receive the process signal 135. According to one alternative exemplary embodiment, the entry system 110 may be any desired other system having control electronics, wherein the device 100 in accordance with the description above may be designed to create a model for use in a test procedure for this system. According to this exemplary embodiment, the vehicle 115 may be in the form of a rail vehicle. According to one alternative exemplary embodiment, the vehicle 115 may be a truck or an automobile. According to this exemplary embodiment, the entry system 110 may be a door system which can be electronically opened and/or electronically closed. For this purpose, according to this exemplary embodiment, the entry system 110 has a door control unit DCU in which the device 100 may be arranged or implemented according to this exemplary embodiment. An arrangement of the device 100 or of individual apparatuses 120, 125 of the device 100 may differ from the arrangement illustrated here. According to one exemplary embodiment, the vehicle 115 has a plurality of entry systems 110, wherein, according to one exemplary embodiment, each of the entry systems 110 has its own door control unit DCU and/or its own ones of the devices 100 described above.

According to this exemplary embodiment, the environment signal 130 represents an item of information relating to a current or defined environment of the entry system 110. According to one exemplary embodiment, the environment signal 130 comprises an item of information relating to an environmental condition such as a location of the entry system 110. According to one exemplary embodiment, the environment signal 130 may be read in from an environment sensor or an input apparatus for manually inputting the information. According to this exemplary embodiment, the process signal 135 comprises at least one item of process information relating to the entry system 110 that may be generated during a resilience test, also called “burn-in test”, of the entry system 110. Additionally or alternatively, according to one exemplary embodiment, the process signal 135 comprises an item of process information relating to the entry system 110 that may be generated during normal operation of the entry system 110. According to one exemplary embodiment, the model 105 has a nominal curve describing a normal state of the entry system.

According to this exemplary embodiment, the device 100 also has a performance apparatus, a comparison apparatus, an output apparatus, a generation apparatus and/or a storage apparatus.

The performance apparatus may be designed to perform the test run of the entry system 110 using the model 105 produced by the production apparatus 125 to obtain a test result. According to this exemplary embodiment, the test run may be a test method carried out on the entry system 110 for the purpose of predicting the state of the entry system 110. In this case, according to one exemplary embodiment, checks and/or wear measurements are performed or effected automatically and/or manually on the entry system 110 to make it possible to identify whether maintenance measures are required. The comparison apparatus may be designed to compare the test result with a reference test result which was obtained based on a reference test procedure performed using a reference model which was produced using a reference environment signal and/or a reference process signal and a reference entry system and/or process and environment signals from operation. The output apparatus may be designed to output a discrepancy signal to a communication interface to a tester, wherein the discrepancy signal may be designed to indicate a discrepancy between the reference entry system and the entry system 110 if the test result and the reference test result do not correspond within a tolerance range. The generation apparatus may be designed to generate the process signal 135 using stored process information representing process information sensed and stored during operation of the entry system 110 in a defined environment. The storage apparatus may be in the form of a non-volatile storage apparatus and may be designed to store process information sensed during operation of the entry system 110 in the defined environment of the entry system 110. The performance apparatus, the comparison apparatus, the output apparatus, the storage apparatus and/or the generation apparatus are implemented, according to one exemplary embodiment, in the door control unit DCU and/or in any desired combination in an apparatus arranged outside the vehicle 115, for example in a server.

The device 100 presented here may be designed to perform an automated test procedure including data recording (burn-in test). In this case, the device 100 may be used to predict a state of a system, here the entry system 110, or a component. A test method for such a prediction may be also referred to in English as “condition based maintenance”, “CBM” for short, or “predictive maintenance”. Creation of nominal curves or models 105 representing a normal state of the respective entry system 110 proves to be difficult during operation on account of changing and sometimes unknown environmental influences. Each entry system 110 behaves differently on account of existing installation/setting tolerances and, for this reason, nominal curves/models recorded on a sample bench cannot be readily applied to all entry systems of this design in the field under defined environmental conditions. The device 100 presented here now makes it possible to provide process and environment data under defined conditions to individually obtain nominal curves/models 105 for the normal state of a system for each system. In this case, according to one exemplary embodiment, the models 105 are regularly compared with identically produced data to identify anomalies.

According to this exemplary embodiment, the device 100 implements a defined process sequence in software of the door control unit DCU in combination with a recording of all available process and environment data and/or a transmission of the data to an infrastructure for evaluation according to this exemplary embodiment. According to one exemplary embodiment, the process sequence may be performed using the device 100 for the first time after the door system has been installed in the vehicle 115. This makes it possible to create the nominal curves/models 105 for the normal state of the respective system 110 by recording data.

According to one exemplary embodiment, the information produced in this manner may be compared in a parallel manner with the reference model produced on a sample bench to identify any installation/setting errors in good time. The process sequence may be initiated either manually at defined times or, according to one exemplary embodiment, the sequence may be called by the device 100 in an automated manner at defined times to produce process and environment data which are used for a comparison with the nominal curves/models 105 produced for the normal state. This makes it possible to identify anomalies and any gradual changes and therefore to predict faults and wear states of the system 110.

According to this exemplary embodiment, the device 100 may be designed to automatically perform test sequences at defined locations, for example a depot and/or a workshop, to exclude changing environmental conditions, in combination with a recording of all process and environment data. Depending on the entry system 110, individual nominal curves/models 105 for the normal state are therefore available, and the current state of the system 110 may be regularly compared with them according to one exemplary embodiment under identical environmental conditions. This enables a higher prediction quality when predicting faults and/or wear. Installation/setting errors of individual systems 110 can be identified and rectified in good time by comparing the individual nominal curves/models 105 for the normal state with reference nominal curves/reference models created on a sample bench.

The description of an exemplary use of the device 100 presented here follows: reference curves/models are created on a sample bench of an entry system series used in a project. The entry systems 110 are then installed in the vehicle 105. This may be followed by starting the defined process sequence, including data recording, under defined environmental conditions (workshop, depot, etc.) using the device 100. This may be followed by the creation of nominal curves/models 105 for the normal state for each entry system 110. Furthermore, the determined information may be compared with that information from the sample bench to identify any installation/setting errors. If necessary, the installation/setting defects found are corrected and the process sequence may then be performed again and nominal curves/models 105 for the normal state of the corrected systems 110 are created. The process sequence may be regularly started, manually or automatically, for example at defined times at night, to compare collected data with the output values and to therefore identify discrepancies or gradual changes.

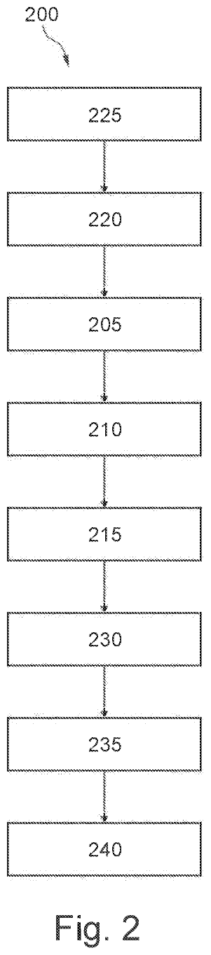

FIG. 2 shows a flowchart of a method 200 for creating a model for use in a test procedure for an entry system for a vehicle according to one exemplary embodiment. This method 200 can be performed and/or controlled by the device described in FIG. 1.

The method 200 comprises a reading-in operation 205 and/or a receiving operation 210 and a producing operation 215. In the reading-in operation 205, an environment signal representing an item of information relating to an environment of the entry system may be read in. In the additional or alternative receiving operation 210, a process signal representing an item of process information relating to the entry system that may be generated during operation of the entry system may be received. In the producing operation 215, the model may be produced using the environment signal and/or the process signal.

According to this exemplary embodiment, the method 200 optionally also comprises a generating operation 220, a storing operation 225, a performing operation 230, a comparing operation 235 and/or an outputting operation 240.

In the generating operation 220, before the receiving operation 210, the process signal may be generated using stored process information representing process information sensed and stored during operation of the entry system in a defined environment. In the storing operation 225, before the generating operation 220, process information sensed during operation of the entry system in the defined environment of the entry system may be stored in a non-volatile storage apparatus. In the performing operation 230, the test run of the entry system may be performed using the model produced in the producing operation 215 to obtain a test result. In the comparing operation 235, the test result may be compared with a reference test result which was obtained based on a reference test procedure performed using a reference model which was produced using a reference environment signal and/or a reference process signal and a reference entry system. In the outputting operation 240, a discrepancy signal may be output to a communication interface to a tester, wherein the discrepancy signal may be designed to indicate a discrepancy between the reference entry system and the entry system if the test result and the reference test result do not correspond within a tolerance range in the comparing operation 235.

The reading-in and/or receiving and producing operations 205, 210, 215 are automatically repeated in a predetermined interval of time according to one exemplary embodiment.

If an exemplary embodiment comprises an “and/or” conjunction between a first feature and a second feature, this should be read such that the exemplary embodiment, according to one embodiment, has both the first feature and the second feature and, according to a further embodiment, has either only the first feature or only the second feature.

### LIST OF REFERENCE SIGNS

DCU Door control unit
100 Device for creating a model for use in a test procedure for an entry system for a vehicle
105 Model
110 Entry system
115 Vehicle
120 Reading-in device
125 Production device
130 Environment signal
135 Process signal
200 Method for creating a model for use in a test procedure for an entry system for a vehicle
205 Reading-in operation
210 Receiving operation
215 Producing operation
220 Generating operation
225 Storing operation
230 Performing operation
235 Comparing operation
240 Outputting operation

1. A method for creating a model for use in a test procedure for an entry system for a vehicle, wherein the method comprises:
reading in an environment signal representing an item of information relating to an environment of the entry system and/or receiving a process signal representing an item of process information relating to the entry system that is generated during operation of the entry system; and
producing the model using the environment signal and/or the process signal.

2. The method of claim 1, further comprising performing a test run of the entry system using the model to obtain a test result.

3. The method of claim 2, further comprising comparing the test result with a reference test result obtained based on a reference test procedure performed using a reference model produced using a reference environment signal and/or a reference process signal and a reference entry system and/or process and environment signals from operation.

4. The method of claim 3, further comprising outputting a discrepancy signal via a communication interface to a tester, wherein the discrepancy signal indicates a discrepancy between the reference entry system and the entry system in response to the comparison indicating that the test result and the reference test result do not correspond within a tolerance range.

5. The method of claim 1, in which the reading-in and/or receiving and producing are automatically repeated within a predetermined interval of time.

6. The method of claim 1, further comprising generating, before the receiving operation, wherein the process signal is generated using stored process information representing process information sensed and stored during operation of the entry system in a defined environment.

7. The method of claim 6, further comprising storing, before the generating, process information sensed during operation of the entry system in the defined environment of the entry system is stored on a non-volatile storage apparatus.

8. A device configured to carry out and/or control a method for creating a model for use in a test procedure for an entry system for a vehicle in corresponding units, wherein an environment signal representing an item of information relating to an environment of the entry system is read in and/or a process signal representing an item of process information relating to the entry system that is generated during operation of the entry system is received, and wherein the model is produced using the environment signal and/or the process signal.

9. A non-transitory computer readable storage medium including a computer program configured to carry out and/or control the method of claim 1.

10. (canceled)

11. The apparatus of claim 8, wherein a test run of the entry system is performed using the model to obtain a test result.

12. The apparatus of claim 11, wherein the test result is compared with a reference test result obtained based on a reference test procedure performed using a reference model produced using a reference environment signal and/or a reference process signal and a reference entry system and/or process and environment signals from operation.

13. The apparatus of claim 12, wherein a discrepancy signal is output via a communication interface to a tester, wherein the discrepancy signal indicates a discrepancy between the reference entry system and the entry system in response to the comparison indicating that the test result and the reference test result do not correspond within a tolerance range.

14. The apparatus of claim 8, in which the reading-in and/or receiving and producing are automatically repeated within a predetermined interval of time.

15. The apparatus of claim 8, wherein a process signal is generated before the receiving operation, wherein the process signal is generated using stored process information representing process information sensed and stored during operation of the entry system in a defined environment.

16. The apparatus of claim 15, wherein process information is stored before the generating operation, wherein the process information sensed during operation of the entry system in the defined environment of the entry system is stored on a non-volatile storage apparatus.
